(19) United States
(12) Patent Application Publication
(10) Pub. No.: US 2003/0158832 A1
(43) Pub. Date: Aug. 21, 2003

(54) Methods and system for defining and creating custom activities within process management software

(76) Inventors: Michael Anthony Sijacic, San Francisco, CA (US); Michal Chmielewski, San Jose, CA (US); Edwin Khodabachian, Sunnyvale, CA (US); Albert Tam, Palo Alto, CA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 09/867,650

(22) Filed: May 31, 2001

(51) Int. Cl. G06F 7/00

(52) U.S. Cl. 707/1

(57) ABSTRACT

A system and method for creating and using custom activities in a process flow is disclosed. A process flow may include a plurality of default activities that are internal to a process manager. Methods and systems consistent with features of the present invention enable custom activities to be created and used by the process manager to allow data or programming logic located outside of the process manager to be used. A custom activity may be created by: writing and compiling a Java™ class that implements a particular interface; defining an XML description file; (3) packaging the Java class and XML description file into an archive file; and (4) associating the archive file with a custom activity that may be brought into the process flow managed by the process manager.

### CROSS-REFERENCE TO RELATED APPLICATIONS

This application relates to applications, Attorney Docket Nos. 06502.0340.00000, entitled “METHODS AND SYSTEM FOR PERFORMING ELECTRONIC INVOICE PRESENTMENT AND PAYMENT DISPUTE HANDLING WITH LINE ITEM LEVEL GRANULARITY,” 06502.0341.00000, entitled “METHODS AND SYSTEM FOR PERFORMING BUSINESS-TO-BUSINESS ELECTRONIC INVOICE PRESENTMENT AND PAYMENT WITH LINE ITEM LEVEL GRANULARITY,” and 06502.0339.00000, entitled “METHODS AND SYSTEM FOR INTEGRATING XML BASED TRANSACTIONS IN AN ELECTRONIC INVOICE PRESENTMENT AND PAYMENT ENVIRONMENT,” filed concurrently with the present application, owned by the assignee of this application and expressly incorporated herein by reference in their entirety.

### DESCRIPTION OF THE INVENTION

1. Field of the Invention

This invention relates to workflow process management systems and, more particularly, to methods, systems and articles of manufacture for generating and implementing custom activities within process management software.

2. Background of the Invention

The basic functionality of a computer is dictated by the type of operating system (OS) it uses. Various operating systems on the market today include Solaris™ from Sun Microsystems Inc., Palo Alto, Calif. (Sun Microsystems), Macintosh® from Apple Computer, Inc., Cupertino, Calif., Windows® 95/98 and Windows NT®, from Microsoft Corporation, Redmond, Wash., and Linux. The combination of an OS and its underlying hardware is referred to herein as a “platform.”

Prior to the popularity of the Internet, software developers wrote programs specifically designed for individual platforms with a single set of system calls and, later, application program interfaces (APIs). Thus, a program written for one platform could not be run on another. However, the advent of the Internet made cross-platform compatibility a necessity and a broader definition of a platform has emerged. Today, the original definition of a platform (OS/hardware) dwells at the lower layers of what is commonly termed a “stack,” referring to the successive layers of software required to operate in an environment presented by the Internet and World Wide Web.

FIG. 1 illustrates a conceptual arrangement wherein a first computer platform 120 and a second computer platform 140 are connected to a server 180 via a network, such as the Internet 160. A resource provider using the server 180 might be any type of business, governmental, or educational institution. Although the resource provider generally has a need to provide its resources to both the user of the first platform and the user of the second platform, the provider does not have the luxury of being able to custom design its content for these individual platforms.

Java™ technology was developed by Sun Microsystems to address this problem by providing a universal platform across multiple combinations of operating systems and hardware that make up the Internet. Java technology shields programmers from the underlying OS/hardware variations through the Java Virtual Machine (JVM), a software-based computing entity that remains consistent regardless of the platform.

The cross-platform architecture of the Java programming language is illustrated in FIG. 2, which shows how the Java language enables cross-platform applications over the Internet. In the figure, the first computer platform 120 and the computer platform 140 are both provided with a JVM 210. The resource provider creates a Java application using the Java software development kit (“SDK”) 211 and makes compiled Java byte codes for the application available on the server 180, which may be running on a third platform. Through standard Internet protocols, both the computer platform 120 and the computer platform 140 may obtain a copy of the same byte codes from server 180 and, despite the difference in platforms, execute the byte codes using their respective JVM 210.

Java technology illustrates the most fundamental principle at work within a stack—the more stable and consistent the software layers are at the lower levels, the easier it is to develop programs at the higher levels. This principle is based on the premise that the higher up the stack the configuration of a platform extends, the more productive programmers who use the upper levels become because of the insulation from the complexity of lower stack levels.

Therefore, effective programming at the application level requires the platform concept to be extended all the way up the stack, including new elements introduced by the Internet. Such an extension allows application programmers to operate in a stable, consistent environment.

A platform that has been developed to facilitate effective application level programming with Internet compatibilities is the Internet Service Deployment Platform (ISDP) developed by iPlanet™ E-Commerce Solutions, a Sun Microsystems™ and Netscape™ alliance. The ISDP gives businesses a very broad, evolving, and standards-based foundation upon which to build an e-enabled solution. FIG. 3 illustrates a block diagram of a stack implementing the ISDP.

As shown in FIG. 3, ISDP 328 sits on top of traditional operating systems 330 and infrastructures 332. This arrangement allows enterprises and service providers to deploy next generation platforms while preserving “legacy-system” investments, such as a mainframe computer or any other computer equipment that is selected to remain in use after new systems are installed.

ISDP 328 includes multiple, integrated layers of software that provide a full set of services supporting application development, e.g., business-to-business exchanges, communications and entertainment vehicles, and retail Web sites. In addition, ISDP 328 is a platform that employs open standards at every level of integration, enabling customers to mix and match components. ISDP 328 components are designed to be integrated and optimized to reflect a specific business need. There is no requirement that all solutions within the ISDP 328 be employed, or that any one or more is exclusively employed.

The ISDP 328 provides certain services utilizing a process manager (PM). The PM enables users to develop, deploy, and manage automated business processes. It may be implemented within an application server, which is conceptually located in the same level of the ISDP as the process manager. The application server allows clients to deploy and manage web-based enterprise applications. The application server manages high volumes of transactions with back-end databases, and offers an open and extensible architecture that is compliant with existing web standards, such as HTTP, HTML, CGI, and Java.

The PM is suited for dynamic, unstructured processes that extend over an extranet or intranet and that require centralized management. The PM allows a user to create web-based applications that define the different tasks in a process, specify who should perform them, and designate the process flow from one task to another. Consider the process for preparing an office for a new employee. Several different activities make up the process-assigning an office, ordering a computer, installing the telephone, installing the computer, and checking that the office furniture has been arranged properly. Some of these tasks need to be performed sequentially, for example, you may order the computer before installing it. Other tasks can be carried out in parallel, for example, you don't need to wait for the computer to be ordered before installing the telephone. Different people perform different tasks-the purchasing department orders the computer, but the information Systems department installs it when it arrives. Other examples of typical PM applications include bidding processes for outside firms, processes for conducting structured negotiations with outside partners, a contractor management process, and applications for processing expense reimbursement requests.

The process manager 578 allows developers to use process design tools that are used to create applications that map the steps in a business process. The business process contains tasks, or workitems, that may require human intervention, such as approving a purchase request, as well as activities that can be completely automated such as retrieving data from databases and writing log files. The process manager 578 enables a user to create and view a workflow process, and the activities included within it using a visual process map and drag-and-drop graphical interface techniques. The visual process map comprises a series of activities and the rules that transfer the flow of control from one step to another. The visual nature of the process map allows the modification of processes, even if the person doing the modification was not the original designer and has little knowledge of the process. Activities can be both manual (processed by people) or automated (through use of scripting or programming).

Generally, the process manager interacts with all of the tasks needed to build applications to control the flow of processes. Accordingly, the need to go outside the process manager 578 to build an application is infrequent. However, in some cases, the need may exist to modify or create new applications using data that is not found within the process manager 578. That is, a process may require the use of an activity that requires programming logic or data that resides outside of the process manager environment. Currently, external access by activities are not supported by the process manager environment, thus limiting the capabilities of a defined automated workflow process.

### SUMMARY OF THE INVENTION

It is therefore desirable to have a method and system that enable custom activities to be created and used in a workflow process that facilitate access to data and programming logic external to the process manager's environment.

Methods, systems and articles of manufacture consistent with the present invention enable a process manager to facilitate the generation and implementation of custom activities in an automated workflow process. A custom activity is created by generating and compiling a Java™ class file that implements an interface to a package external to a process manager environment. Also, an extensible Markup Language (XML) description file is defined for the Java™ class. These two files are packaged into an archive file and associated with a custom activity visual representation. The custom activity may be added to an application by dragging the visual representation to a process map that presents the steps included in an application process.

In another aspect of the present invention, the XML description file is created by defining selected sections for obtaining data field values associated with the class file, and placing values into selected data fields through the use of hashtables. A user may inspect the association of parameters corresponding to selected data fields by viewing the hashtable's contents through an inspector window.

Furthermore, methods and systems consistent with the present invention enable the class file to be generated by defining a package for the class, and init( ), perform( ) and destroy( ) methods that are associated with the interface the class file is designed to implement.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings,

FIG. 1 illustrates an exemplary multiple platform environment;

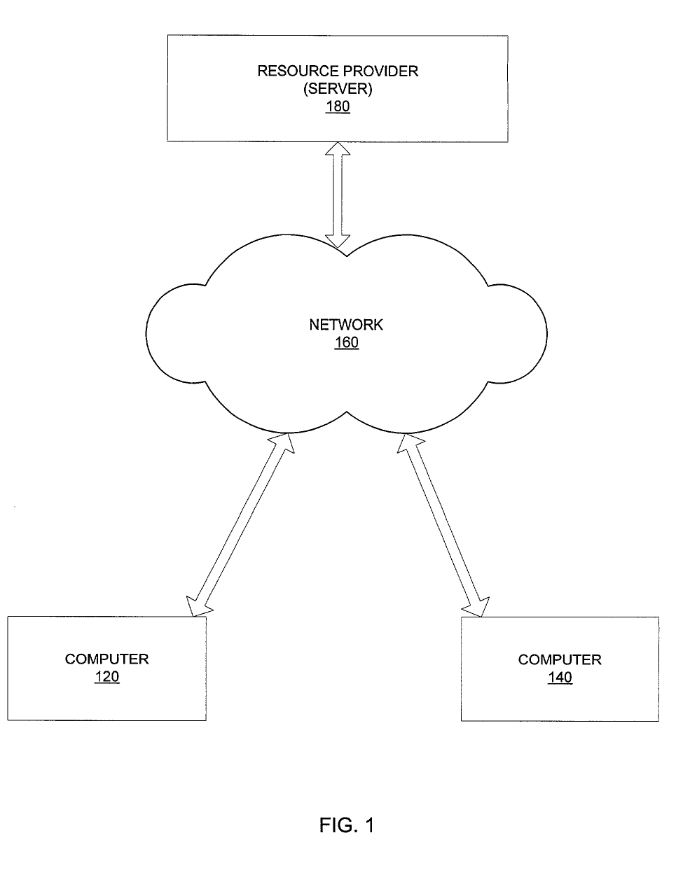

FIG. 2 illustrates an exemplary multiple platform environment including Java™ applications;

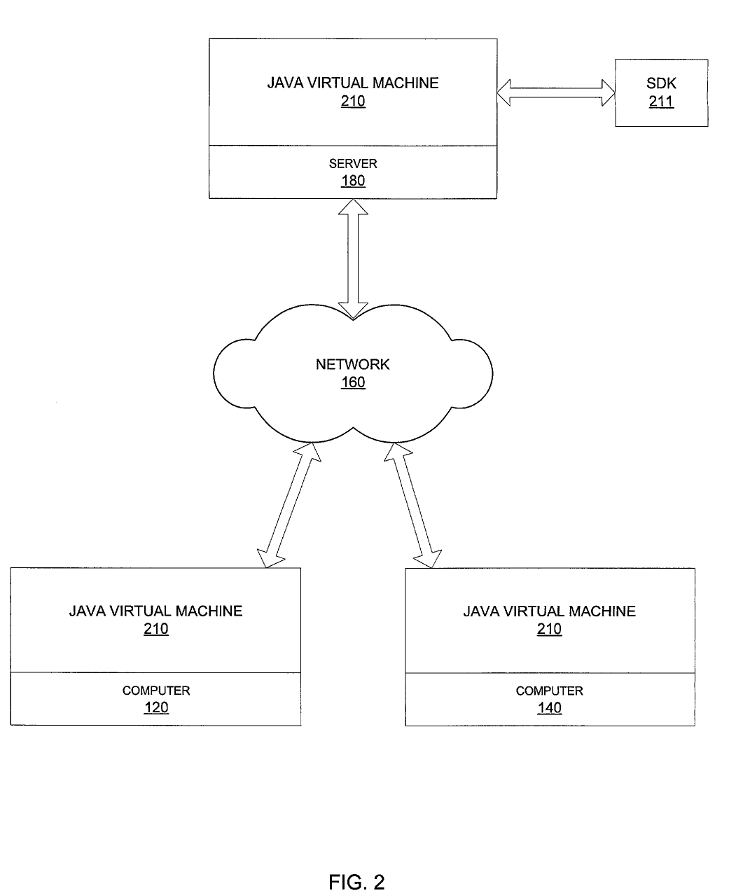

FIG. 3 illustrates an exemplary block diagram of a stack including the Internet Service Development Platform;

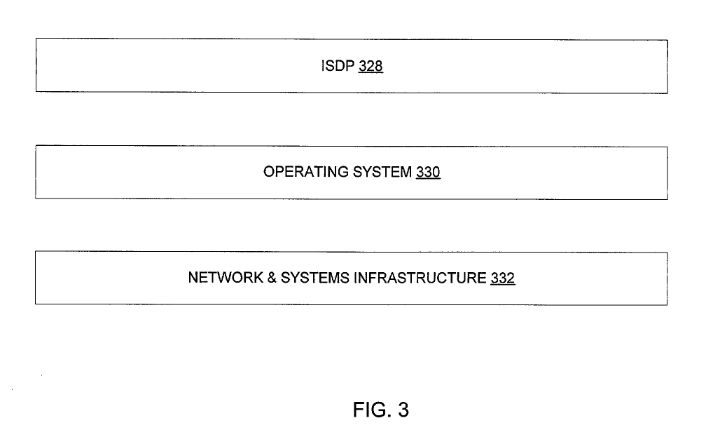

FIG. 4 illustrates an exemplary computer system in which features and principles consistent with the present invention may be implemented;

FIG. 5 illustrates an exemplary process manager in which features and principles consistent with the present invention may be implemented;

FIG. 6 illustrates an exemplary process builder interface in which features and principles consistent with the present invention may be implemented;

FIG. 7 illustrates another exemplary process builder interface in which features and principles consistent with the present invention may be implemented;

FIG. 8 illustrates an exemplary process for creating a custom activity in which features and principles consistent with the present invention may be implemented;

FIG. 9 illustrates an exemplary process for creating a class file in which features and principles consistent with the present invention may be implemented;

FIG. 10 illustrates an exemplary archive file interface in which features and principles consistent with the present invention may be implemented;

FIG. 11 illustrates exemplary icons associated with a custom activity in which features and principles consistent with the present invention may be implemented;

FIG. 12 illustrates an exemplary process for creating a custom palette in which features and principles consistent with the present invention may be implemented;

FIG. 13 illustrates an exemplary interface associated with the process for creating a custom palette in which features and principles consistent with the present invention may be implemented;

FIG. 14 illustrates another exemplary interface associated with the process for creating a custom palette in which features and principles consistent with the present invention may be implemented;

FIG. 15 illustrates another exemplary interface associated with the process for creating a custom palette in which features and principles consistent with the present may be implemented;

FIG. 16 illustrates another exemplary interface associated with the process for creating a custom palette in which features and principles consistent with the present invention may be implemented;

FIG. 17 illustrates an exemplary interface associated with a custom palette in which features and principles consistent with the present invention may be implemented; and

FIG. 18 illustrates an exemplary inspector interface associated with hashtables in which features and principles consistent with the present invention may be implemented.

### DETAILED DESCRIPTION

Methods, systems and articles of manufacture consistent with features of the present invention facilitate the generation and implementation of custom activities in a process management environment. A custom activity may be created by first generating and compiling a Java class file that implements an interface to external packages. The interface may define a custom activity that may obtain values as input parameters, perform some task, and set data field values as output parameters. Following the compiling of the Java class file, an XML description file is defined for the Java class. The XML file defines the format and output parameters that the class uses. After both the Java class and XML description files are created, they are packaged to create a custom activity archive file. Along with the XML description file and Java class files, the archive file may include image files that provide graphical representations associated with the defined custom activity that may be used when implementing the custom activity.

Additionally, methods, systems and articles of manufacture consistent with features of the present invention enable defined custom activities to be created using a visual map palette that includes graphical representations, or icons, that reflect selected activities that may be used in a process. Included in the map palette may be a custom activity icon that reflects a defined activity for accessing data or resources external to the process manager environment. In one aspect of the present invention, the custom activity may be associated with a custom visual map palette that is used to present custom activities.

Methods, systems and articles of manufacturer consistent with the present invention may also allow custom activities to be implemented in a process by using visual drag-and-drop techniques. Particularly, when a custom activity is implemented into a process, the visual representation associated with a custom activity may be dragged into a process map that reflects a process including steps, or activities, that are performed to execute an application process.

Reference will now be made in detail to the exemplary embodiments of the invention, examples of which are illustrated in the accompanying drawings. Wherever possible, the same reference numbers will be used throughout the drawings to refer to the same or like parts.

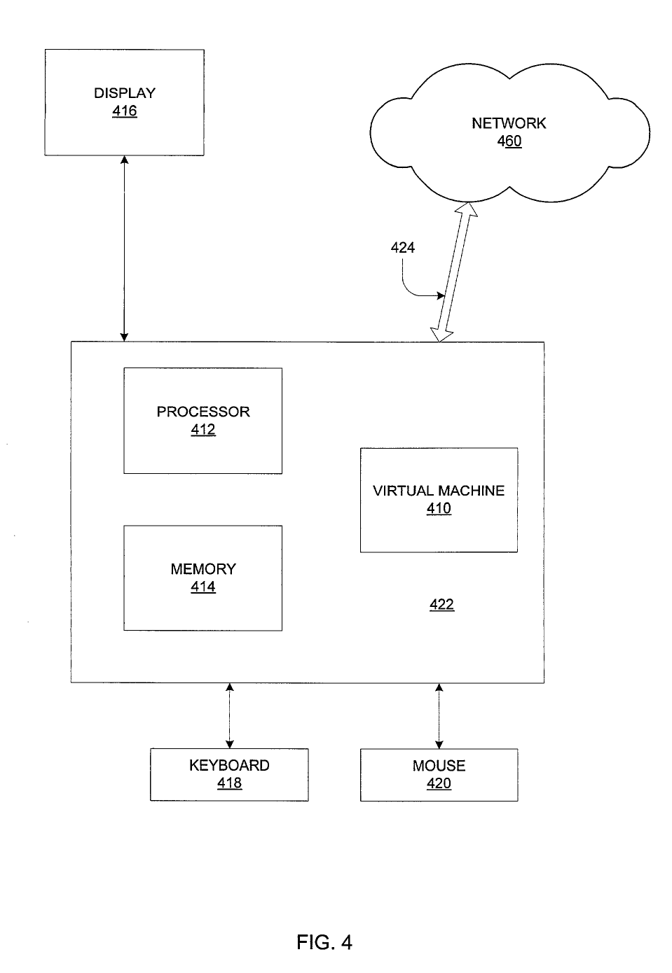

Virtually any type computer regardless of the platform type may be used to implement methods and system consistent with the present invention. For example, as shown in FIG. 4, a typical computer 422 has a processor 412, associated memory 414, and numerous other elements and functionalities typical to today's computers (not shown). The computer 422 has associated therewith input means such as a keyboard 418 and a mouse 420, although in an accessible environment these input means may take other forms. The computer 422 is also associated with an output device such as a display 416, which may also take a different form in an accessible environment. Computer 422 is connected via a connection means 424 to a network such as the Internet 460. The computer 422 is configured to run a virtual machine 410, implemented either in hardware or in software.

Accessing a computer system, such as the one described in FIG. 4, that is configured in accordance with features and principles of the present invention, a developer may harness the capabilities of a process manager to create web-based applications that define different tasks in a process, specify who should perform the tasks, and map out how the process flows from one task to another. The tasks that the process manager may perform include: (1) designing a process by enabling process designers to employ a process builder component to create and deploy an application that maps the steps in a business process; (2) performing tasks in a process by implementing a process express component that provides a web-based interface; and (3) administering processes by implementing a process administration component that provides a web-based interface for administrators to perform administer process applications, such as shutting down processes.

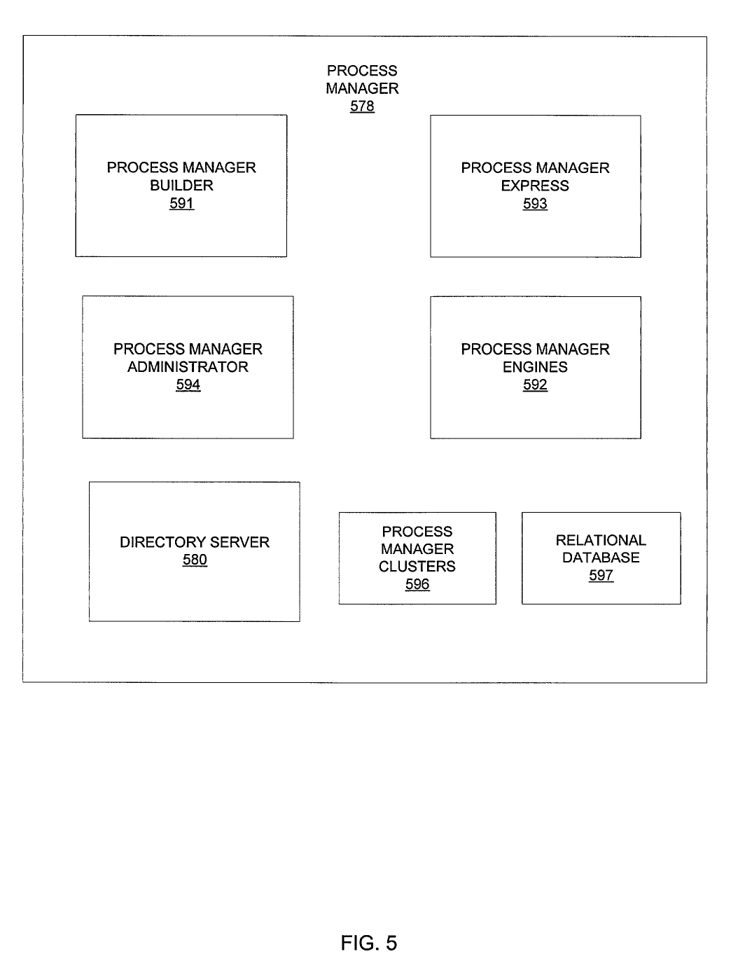

FIG. 5 illustrates a process manager PM 578 consistent with features and principles of the present invention. PM 578 is designed using a web-centric model. The forms that users access are based on HTML, and these web pages can be extended using JavaScript™, Java™ applets, JavaBeans™, and other customized components. Web browsers are the ideal platform for users of business processes because of broad deployment.

As a web application, PM 578 can be readily distributed among multiple servers in a network. With this approach, process participants can be connected together without the need for local proximity. The process participants are able to draw on a number of resources on an intranet or extranet to complete specific activities, and the participants also have access to a set of references and documents needed to complete the activity. Connectivity through the web also provides a ready mechanism for participants to have visibility into the status of in-process items.

PM 578 is based on widely adopted web standards and protocols and is designed to be browser-neutral with support for both Netscape™ Navigator and Microsoft® Internet Explorer. HTML is the standard for forms, and these forms can include any combination of text, graphics, and client-side scripting. Because the forms use HTML, pages produced by other editors can be incorporated into a process. PM 578 uses Hypertext Transfer Protocol (HTTP) as the standard transport protocol for browser access. Process extensions are implemented using JavaScript™ rather than a proprietary scripting language. Process definition objects are stored in Lightweight Directory Access Protocol (LDAP)-capable directories to allow for replication and distribution throughout an organization. At run-time, process participant roles are also resolved through LDAP-accessible organizational directories. In addition, process state information is stored in standard relational databases rather than proprietary content stores.

The benefit of the above described approach is to facilitate ready deployment within organizations, and to allow for direct integration into the corporate infrastructure and with extranet partners. Most organizations have deployed web infrastructures (HTTP transport, web browsers) which can be directly leveraged. The broad deployment of LDAP as a directory access protocol allows for ready access to organizational hierarchy information. In addition, leveraging preexisting infrastructure minimizes the need for retraining of systems support staff.

PM 578 is designed for extensibility using client- and server-side scripting using JavaScript functions. This provides a flexible environment for extended capabilities without the overhead of a complete programming environment. Intelligent HTML forms can include JavaScript expressions for field validation and checking. These forms can also include customized components for tasks like file transfer and directory lookup.

As shown in FIG. 5, PM 578 may be organized into several distinct components. FIG. 5 illustrates an exemplary block diagram showing the components included within PM 578. These components may include: a Process Manager Builder (PMB) 591; Process Manager Engines 592; a Process Manager Express 593; a Process Manager Administrator 594; a Directory Server 580; a relational database 597; and PM clusters 596.

PMB 591 is a visual process design tool that is used to create and deploy PM applications that maps the steps in a business process. PMB 591 allows enterprises to control which steps are included in a process and the sequence of those steps, and to embed business rules in the processes. Therefore, processes are efficient, reliable, and adhere to specific business policies. Using PMB 591, which is a graphical user interface with drag and drop capability, a developer builds a process application that controls the flow of a process. The process contains tasks, or workitems, that require human intervention, such as approving a purchase request, as well as activities that can be completely automated such as retrieving data from databases and writing log files. PMB 591 is where individuals, groups, or roles are assigned responsibility for process steps included in a process map. This assignment of responsibility is facilitated through the builder's tight integration with LDAP directory servers.

PMB 591 is also used to develop Hypertext Markup Language (HTML) forms that serve as the process interface for end users. Forms can include client-side JavaScript for field input validation. Forms can also be extended by incorporating JavaBeans and applets that are used to encapsulate business logic. Forms and associated processes can have any number of documents attached to them using a file attachment object. Access to the forms and the various process data they contain is controlled via the Process Manager Builder Forms Access grid.

Once the process definitions are developed in PMB 591, the application is deployed. When a PM application is deployed, three steps are performed. First, the application is written to the PM configuration directory. Next, the application is initialized on all Process Manager Engines 592 in a PM cluster 596. Lastly, the tables are created in the relational database 597.

The Process Manager Engines 592 run inside the Enterprise Server and hosts applications at run-time, including extranet applications. Process Manager Engines 592 read process definitions from LDAP-based directories and leverages the Simple Workflow Access Protocol (SWAP) to integrate with process automation solutions from different vendors and utilizes Enterprise Server scalability for extranet access. Process Manager Engines 592 also integrate with any SMTP messaging server and uses clustering.

Access to established processes is accomplished through the Process Manager Express 593, a browser-based HTML interface where users can access specific workitems, initiate new process instances, delegate workitems to others, and query the status of in-process workitems. A web-based work list (much like an in basket or to do list) may be displayed to let a person know that a task has been assigned to them. When the assignee is ready to perform the task, Process Manager Express 593 may display a form that provides the data needed to perform the task. When the assignee has performed the task, data that may be needed to complete the task is entered and the form is submitted. Following such a submission, the workitem may automatically disappears from the assignee's work list. The process moves onto the next step and the next task shows up in the work list of the appropriate person. Process Manager Express 593 automatically performs any automated tasks that do not require human intervention.

The Process Manager Administrator 594 is a web-based administrative console accessible via any standard web browser. The Process Manager Administrator 594 serves two functions: (1) managing the PM cluster 596 (that includes, the Process Manager Engines 592, the LDAP directory servers 595, and the relational database 597); and (2) monitoring and managing the deployed processes/applications that are installed on the clusters.

The Directory Server 580 (or any other LDAP capable directory server) is used for process object definition storage as well as for resolution of roles at run-time. Storage of process objects in the directory allows for replication, broader distribution, and centralized management.

A relational database 597, such as Oracle® and Sybase,® is used to store the state or process instances. PM applications are isolated from the process state database through a LiveWire database access API. PM 578 delivers ease of administration by automatically defining the database table schema at the time that applications are loaded into the PM cluster 596, without the need for intervention by an administrator. This schema is construed based on the data dictionary components that are defined at the time of development.

In a cluster configuration, multiple engines are connected to a single shared database. Because all Process Manager Engines 592 access the same database 597, and all are a persistent state is in the database, these engines function as a single logical server. This architecture gives PM its failover capability, because any engine in a cluster can serve a process in the event another engine in the PM cluster 596 fails. As previously noted, engines can be added to the PM cluster 596 for increased application scalability. Administrators can add engines to the PM cluster 596 without having to shut down applications, thereby ensuring continuity of service and further easing management.

As explained, PMB 571 operates within process manager 578 to facilitate all of the tasks needed to build applications to control the flow of processes. Separate applications may be created for each process. For instance, a process of submitting a vacation time request and a process for submitting an expense report are two different applications. When users submit their first request in a process manager application, they initiate what is called a process instance. Each user's request generates a unique process instance. The point where a user initiates a process instances is called an entry point. The process instance ends at an exit point.

Process applications may be created using the process manager builder 591 by generating a graphical view of the steps in the process from beginning to end. The view is called a process map. Everything that relates to the steps in the process are defined, including forms, data fields, scripts and access to the forms.

Application elements may be represented in a window called an application tree view. This window resembles a typical file system view. That is, the window may use folders to represent element categories and the folders each may contain corresponding application elements.

When a developer creates steps in a process, icons may be dragged from a palette that represent activities that are used to create a process. Steps are connected by drawing arrows, or transitions, between the icons. As the process map is constructed, and new data fields, forms and scripts are inserted, these items are added to the application tree view. Accordingly, the folders within the tree view may be filled with items represented on the process map. Because all application elements may be represented in the application tree view, the element's properties may be readily accessible and edited.

Once an application is created, it may be saved to a folder located in a user's local machine or deployed to a cluster. When the application is saved to a user's local machine, all of the definitions are stored in a local applications folder that is located within a builder folder created at the local machine. Deployed applications are stored in clusters. Thus, when process manager builder is launched, a list of all of the clusters specified in a preference file are provided to the user. Deployment may be executed in two stages. The first stage is a development stage that enables changes to be made to the application. The second stage is a production stage that enables end users access to the completed application.

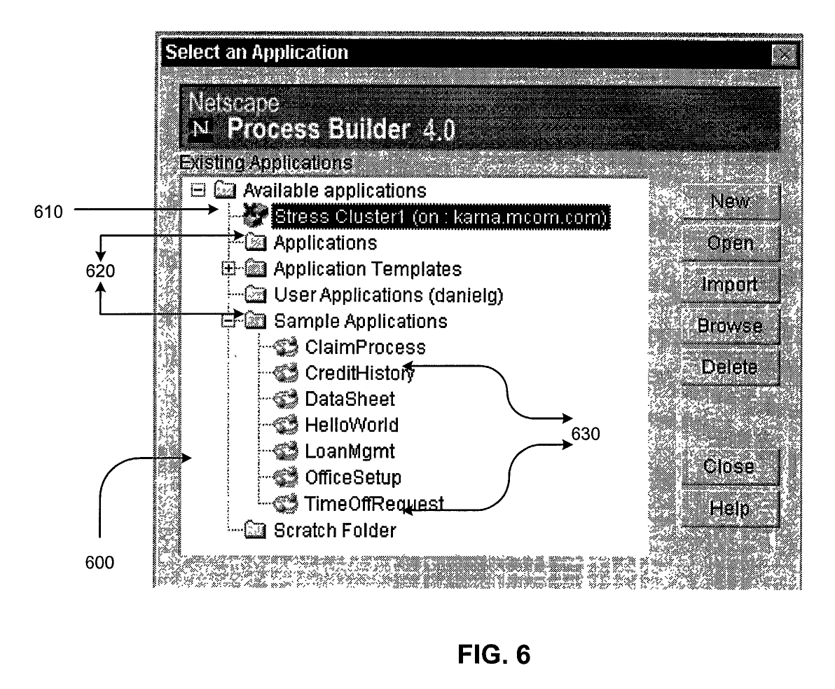

FIG. 6 shows an exemplary window that may be presented when process manager builder is launched. The left pane of the window 600 shows a list of all clusters 610, the applications deployed to them 620 and applications saved locally in applications directories 630. The applications in the clusters have labels indicating whether they were deployed in the development stage or in the production stage.

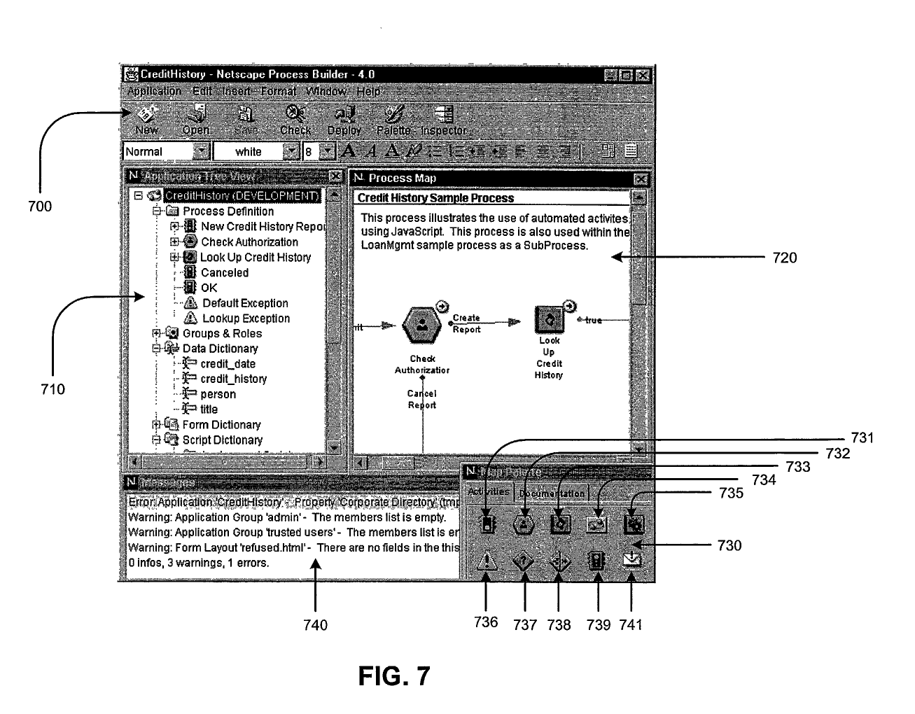

FIG. 7 shows an exemplary view of an interface for PMB 591 when an existing application (called “CreditHistory”) listed in the window depicted in FIG. 6 is opened. As shown, window 700 includes a tree view 710, a process map 720, a map palette 730 and a messages window 740.

Applications tree view 710 lists all of the elements in an application. Each application may have a set of default elements, shown as a set of standard folders and icons. Messages window 740 may present error, warning and information messages when an application's syntax is being analyzed. The syntax of an application is automatically checked by the process manager system when the application is deployed.

Deploying an application makes it available to test and use. As previously explained, an application may be deployed to either a development or production stage. The development stage allows an application to be tested and edited by a developer. While in the development stage, PM 578 assumes that data or work items need not be preserved. Accordingly, selected changes to an application may not be saved. Thus, when an application is redeployed that has been modified in a development stage, all process instances are deleted. The production stage, on the other hand, allows the application to be used without losing process instances or selected changes to data. Furthermore, certain application information may be changed in the production stage.

The process map 720 provides a visual representation of an application. It may show the steps (activities) needed to complete the process and how they are connected. When a new application is created, this window may be blank. However, if an existing process is being revised, the current version of the process appears in the map window 720. As shown in FIG. 7, process map window 720 includes exemplary activities and that represent the steps performed within the sample process and transition lines that reflect how the activities are interconnected in the process.

Configured below the process map window 720 is an exemplary map palette 730. Map palette 730 may include two tabs, activities and documentation. The activities tab displays icons that may be dragged onto the process map 720 to design a process application. Each of these palette items may represent a type of step in a process, notification or an error response.

For example, icon 731 may represent an entry point activity in a process. This activity is where a user may initiate a process. Applications may have several entry points. Icon 732 may represent a user activity. A user activity may be a step within a process that requires a user to perform a task. Each user activity may have an assigned user who performs the task (Assignee) and a form the user needs to fill out in process manager express. After activities are placed in a process map, the sequence in which they are to be executed is defined by connecting them with transition lines. Icon 733 may represent an automated activity that is performed through a JavaScript™ script without user intervention. Icon 734 may represent a subprocess which may be a step that calls a process from within another process. The process that calls the subprocess is considered to be the parent process and the subprocess is considered the child process. A parent process may have several children processes, each of which is a stand-alone process complete with entry and exit points. Icon 736 may represent an exception manager activity that is a step that allows the administrator to intervene manually if an error occurs when a user runs the application. Icon 737 may represent a decision point activity that may be a conditional step that causes the process to use different steps based on a condition. Icon 738 may represent a parallel processing activity that is a step within a process that branches in two or more branches to enable two or more activities to execute in parallel. Icon 739 may represent an exit point. An exit point is a step at which a process ends. An application may have several exit points. And, icon 741 may represent a notification activity that may be associated with an email notification that is triggered when a user activity is started. The email notification may serve many purposes such as notifying a person who started the process or other users of the process's progress.

The above described activities represented by the icons included in the map palette 730 may be default activities that users may use to build an application. However, when programming logic or data resides outside of process manager, a user may define a custom activity to utilize this information. Icon 735 represents a custom activity that may perform user specified functions with external entities and/or data.

Custom activities are useful when a user wants to do more than can be easily done in an automation script. For example, a user might want to build a custom activity to interface with external applications and databases. Custom activities may also run local applications and then interact with mail gateways or FAX server. Furthermore, custom activities are useful when it is desired to integrate an existing legacy process into a process manager process through a well-defined interface. For example, a custom activity may be used in a process manager process that exchanges data with external resources such as a CORBA server, a CICS system or the business logic in an Enterprise JavaBean. Also, custom activities are advantageous for situations where data can be parsed and stored either directly in a data field or in a content store. Process manager 578 enable users to create custom activities as Java™ classes and bring them into a process' definition.

Custom activities are similar to the automated activities in that they may be placed on a process map by dragging and dropping them from a map palette. Furthermore, custom activities may also employ verification and completion scripts and are triggered as soon as a process instance reaches the activity, unless the activity is deferred. A deferred activity may be triggered at a specified date and time. Although custom activities share some common characteristics with automated activities, there is a difference between the two. The difference is that automation activities are carried out by an automation script while custom activities are carried out by a user defined Java class.

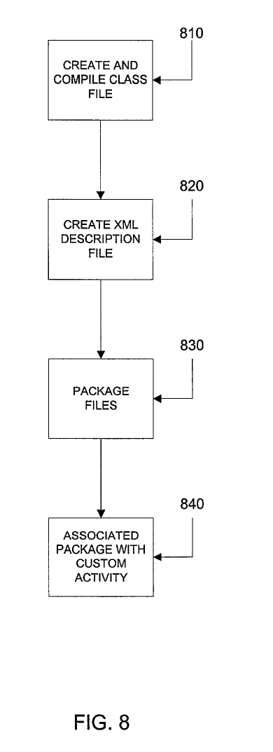

In order to enable user's to take advantage of custom activities, they must be created. FIG. 8 illustrates an exemplary process for creating a custom activity. As shown in FIG. 8, to create a custom activity a Java class is first generated and complied (Step 810). Next, an XML description file for the activity is defined (Step 820). The XML description file and the defined Java class are then packaged into an archive file (Step 830). And finally, the custom activity may be brought into an application for use by associating a visual representation with the custom activity's archive file (Step 840).

I. Creating and Compiling a Java Class

With respect to the first step of creating a custom activity, the Java class should be created and compiled to implement a work performer interface that is a process interface to certain software packages (collection of processes that may be used by a process manager environment when a defined process is executing). This interface for exemplary purposes may be called ISimpleWorkPerformer. ISimpleWorkPerformer may be an interface to a package, such as com.netscape.pm.model., and may define a custom activity that gets values, typically data field values, as input, performs some task, and sets data fields values as outputs. The work performer interface, such as ISimpleWorkPerformer, may have three methods consistent with features of the present invention. These methods include: (1) an init( ) method that is called when an application starts; (2) a perform( ) method that is called each time a custom activity is executed; and (3) a destroys method that is called when an application is unloaded or removed.

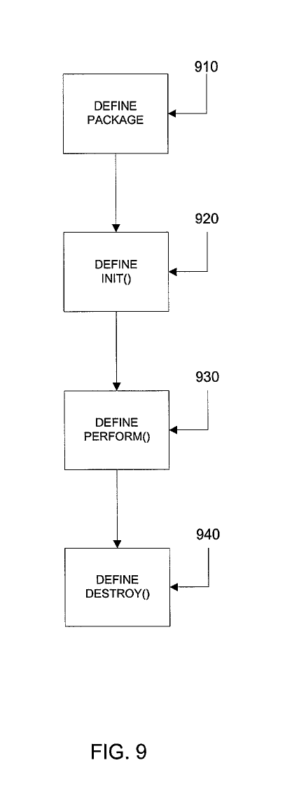

FIG. 9 shows an exemplary process for creating a class file consistent with features of the present invention. The first step in creating the file is to define a package for the class (Step 910). This process may involve importing defined packages from a source external to the process manager environment that may be used by the class file. Also, the class may be defined to implement an interface to a package, such as the ISimpleWorkPerformer interface to the package com.netscape.pm.model, previously described. Furthermore, in addition to defining the implementation of the class, variables that may be needed by the class file are also defined. For further understanding of this process step, an example of a Java class file is described later.

Following the package definition step, the init( ) method associated with the interface are defined (Step 920). The init( ) method may perform initialization tasks that a custom activity requires when an application starts. For example, init( ) method may be used to set up database connections that are shared by all instances of a custom activity. Additionally, init( ) method may be used to define variables that are constant across all instances of the activity. The init( ) method may be represented as:

public void init (Hashtable environment) throws exception

The init( ) method does not execute each time a custom activity is created in a process instance. Instead, this method is called only once-when the application starts.

As an input argument, init( ) uses a hashtable of environment variables. A hashtable is a Hashtable object that contains a series of parameter-value pairs. The parameters in the environment hashtable are defined in an ENVIRONMENT section of an XML description file. The XML description file defines the format and output parameters that the class uses, and will be described in greater detail later. A process designer sets the values of the hashtable parameters while creating the process map. For example, suppose a Language parameter is defined in an environment hashtable of a custom activity. In process manager builder 391, the Language parameter would appear as a property for the custom activity.

In a Java class, init( ) method is defined to perform desired initialization tasks. Once defined, the value of a parameter in an environment hashtable may be obtained by calling a get( ) method on the environment hashtable. The get( ) method returns either the value of the parameter, or a null value if the parameter does not exist.

Referring back to FIG. 9, after the init( ) method is defined, the perform( ) method may be established (Step 930). The perform( ) method executes whatever tasks that may be done for the custom activity. This method takes two Hashtable arguments and may be represented as:

public void perform (Hashtable in, Hashtable out) throws exception

The input hashtable contains values taken from data fields and the output hashtable contains values to put into data fields. The parameters in the input and output hashtables are defined in the IPUT and OUTPUT sections, respectively, of an XML description file, which will be described later.

To obtain the value of a parameter in the input hashtable, a get( ) method is called on this hashtable. The get( ) method returns either the value of the parameter, or null if the parameter doesn't exist. Because the get( ) method returns a Java object, this object may be cast to the object class type that a custom activity is expecting. For example:

string sizeOrder=(String) input.get(“order”);

To set data field values, the perform( ) method may put values into the output hashtable by calling a put( ) method on the output hashtable. When the perform( ) method finishing executing, the values to the corresponding data fields are then assigned.

Once the init( ) and perform( ) methods are established, the last method, destroy( ) may be defined (Step 940). The destroy( ) method is called when the application that uses a custom activity is unloaded or removed. Typically the destroy( ) method is used to clean up resources that were used by the init( ) method.

a. An Example Java™ Class

To facilitate the understanding of the features and principles of the present invention, an example of how an exemplary Java class is created will be described. The following code samples represent a class (HelloWorldPerformer.java) that implements a custom activity called HelloWorld. This exemplary custom activity constructs a welcome message in either French or English. The message value is derived from two things: (1) the value of the customerName data filed in the process instance; and (2) the Language property of the HelloWorld activity instance. The HelloWorld activity puts the welcome message in a greeting data field.

1. Define a Package for the Class

To create the exemplary HelloWorldPerformer.java class, a Java™ editor and compiler may be used to create and compile a Java™ class that implements the ISimpleWorkPerformer interface. The first step in creating the Java class is defining a package for the class:

package com.netscape.pm.sample;

The required standard Java packages are then imported:

import java.lang.*;

import java.util.*;

The class HelloWorldPerformer is defined to implement com.netscape.pm.model.ISimpleWorkPerformer as follows:

public class HellowWorldPerformer

implements com.netwscape.pm.model. ISimpleWorkPerformer

{

After the class HelloWorldPerformer is defined, two variables to hold the English and French components of the greeting, and another variable associated with the complete greeting when it is derived are defined as follows:

// Greeting Messages
public static final String GREETING_FRENCH = “Bonjour” ;
public static final String GREETING_ENGLISH = “Hello” ;
// Holds the greeting message once the language is specified
String mGreeting ;

2. Define the Init( ) Method

The init( ) method is then defined to get the value of the Language environment variable and to set the language-specific part of the greeting. In addition, an exception condition is defined to throw an exception if the language is not provided, or if the language is neither English nor French. For example:

/**
* The HelloWorld custom activity knows to generate both French and English greetings.
* The Language argument defines which argument defines which language should be
* used.
*/
public void init( Hashtable env ) throws Exception
{

String lang = (String) env.get( “language”) ;
if( lang == null )
{

throw new Exception( “-- language not defined.”) ;

}
else if ( lang.equalsIgnoreCase(“French”) )
{

mGreeting = GREETING_FRENCH;

}
else if ( lang.equalsIgnoreCase(“English”)
{

mGreeting = GREETING_ENGLISH;

}
else
{

throw new Exception( “-- Unknown language:” + lang
+ “. We currently support English or French--“ ) ;

}

}

3. Define the Perform( ) Method

The perform( ) method is defined to construct a welcome message consisting of the language-specific part of the greeting and the user's name, for example “Hello Billy.” The value of a userName parameter is derived at a later time, using a data field in a process instance that uses the custom activity. The get( ) method is used on the input parameter to get the value of the input parameter. Referring to the example set forth above, the perform( ) method may be defined as follows:

/**
* Reads the username element of the input hashtable, generates greetings, and
* sets the Greeting element of out.
*/
public void perform ( Hashtable input, Hashtable output )

throws Exception

{

// Read the username attribute from the input hashtable
String username = (String) input.get( “username” );
if( username == null)

{

throw new Exception(“userName is not initialized!”);

}

// Generate greetings
String msg = mGreeting + “ “ + userName;
/* Use the put( ) method on the output parameter to set
* the value of an output parameter.
*/
// Put the greeting into the welcomeMsg parameter of
// the output hashtable.
output.put( “welcomeMessage” , msg);

}

4. Define the Destroy( ) Method

After the init( ) and perform( ) methods have been defined, the destroy( ) method may be defined. The destroy( ) method is invoked when an application is unloaded from the application server. Referring to the above example, the destroy( ) method does nothing because no resource cleanup is needed. For example:

public void destroy( ) {}

//End of class }

Once HelloWorldPerformer.java is defined, it is compiled by PM 578 into the class file HelloWorldPerformer.class.

II. The XML Description File

Once a Java class that implements the ISimpleWorkPerformer interface is created and compiled, an XML description file for the class is defined. The XML description file specifies the environment, input, and output parameters that the class uses. In addition, the XML file specifies some optional design parameters that may control the custom activity's appearance in the process builder 391.

The format of an XML description file starts with a tag indicating the XML version, such as: <?XML version=“1.0”?>

The body of the description file is contained within an opening <WORKPERFORMER> tag and a closing </WORKPERFORMER> tag. Within the WORKPERFORMER section are defined four sections. These sections are summarized in Table 1, below.

TABLE 1
WORKPERFORMER Sections

| XML Section | Section Description |
|---|---|
| ENVIRONMENT | Environment hashtable used by init( ) method |
| INPUT | Input hashtable used by perform( ) method |
| OUTPUT | Output hashtable used by perform( ) method |
| DESIGN | Appearance of custom activity in the process builder |

The XML description has the following general structure:

<?XML version = 1.0” ?>
<WORKPERFORMER>
<ENVIRONMENT>

<PARAMETER> . . . </PARAMETER> . . .

</ENVIRONMENT>
<INPUT>

<PARAMETER> . . . </PARAMETER> . . .

</INPUT>
<OUTPUT>

<PARAMETER> . . . </PARAMETER> . . .

</OUTPUT>
<DESIGN>
</WORKPERFORMER>

a. The WORKPERFORMER Section

The WORKPERFORMER section includes four attributes: TYPE, NAME, CLASS_ID, and VERSION. The TYPE attribute is the full package name for the Java™ class for the type of custom activity. For a simple custom activity, the TYPE attribute may be:

com.netscape.pm.model.ISimpleWorkPerformer

The NAME attribute is the name of the custom activity. The custom activity name is generally the same name as the name of the XML description file and an archive file that contains the custom activity. The CLASS_ID attribute is the full package name for the Java™ class that implements the custom activity. And the VERSION attribute is the version of the custom activity. This attribute is optional and may be used to keep version information about the description file.

The following is an example of a <WORKPERFORMER> tag:

<WORKPERFORMER

TYPE= “com.netwscape.pm.model . ISimpleWorkPerformer”
NAME= “HelloWorld”
CLASS_ID= “com.netscape.pm.sample.HelloWorldPerformer”
VERSION= “1.1”>

b. The ENVIRONMENT Section

The <ENVIRONMENT> tag within the ENVIRONMENT section defines parameters that are constant within all instances of the custom activity. For Example, suppose that in an application named HelloWorld, the value of the language environment parameter is set to French. Then, the value is always French in every process instance of that application.

The <ENVIRONMENT> tag contains embedded <PARAMETER> tags. Each <PARAMETER> tag describes a parameter in the environment hashtable—the argument used by the init( ) method. The <ENVIRONMENT> tag has a corresponding closing </ENVIRONMENT> tag and each <PARAMETER> tag also has a closing </PARAMETER> tag. The notation <NAME> indicates a beginning tag whereas the notation </NAME>indicates a closing tag.

The following is an example of an ENVIRONMENT section:

<ENVIRONMENT>

<PARAMETER NAME= “Language”>“French” </PARAMETER>

</ENVIRONMENT>

c. The INPUT Section

The <INPUT> tags included in the INPUT section of an XML description file contain <PARAMETER> tags. Each of these <PARAMETER> tags specify a JavaScript™ expression that returns a value for the input hashtable to be used as the argument in the perform® method. The <PARAMETER> tag can specify any JavaScript™ expression as the parameter. The <INPUT> tag has a corresponding closing </INPUT> tag, and each <PARAMETER> tag has a closing </PARAMETER> tag.

In order for a value of a data field in a process instance to be used as an input parameter, a call to getData( ) is embedded in the <PARAMETER> tag. For example, the following code sets the value of a userName parameter in an input hashtable to the value of the customerName data field in the process instance.

<INPUT>

<PARAMETER

NAME= “userName”
DISPLAYNAME= “User Name”
TYPE= “java.org.lang.String”
DESCRIPTION= “Last Name”>

getData(“customerName”)
</PARAMETER>

</INPUT>

The corresponding code in the Java™ class file will use the perform( ) method to obtain the value of the userName parameter. Within the perform( ) method of the Java™ class file, the get( ) method is called. The following code is an example of how a perform( ) method may call the get( ) method to obtain a desired value of the userName parameter:

public void perform(Hashtable input, Hashtable output)

throws Exception

{

// Read the userName attribute from the input hashtable
String userName = (String) input.get( “userName” );
if( userName == null )
{

throw new Exception(“userName is not initialized!”) ;

}
// Generate greetings
String msg = mGreeting + “ “ + userName;

d. The OUTPUT Section

The <OUTPUT> tag included within the OUTPUT section of the XML description file contains <PARAMETER> tags. Each <PARAMETER> tag may specify JavaScript™ parameters that define what to do with parameters in the output hashtable, which is the output argument of the perform( ) method. The <OUTPUT> tag has a corresponding closing </OUTPUT> tag, and the <PARAMETER> tag has a closing </PARAMETER> tag.

A mapTo( ) JavaScript™ function may be used to specify that the value of a parameter of the output hashtable is to be automatically installed in a data filed in the process instance. For example, the following code specifies that when the perform( ) method has finished executing, the value of a welcomeMsg parameter in the output hashtable is automatically installed in the greeting data field within the process instance.

<OUTPUT>

<PARAMETER

NAME= “welcomeMsg”
DISPLAYNAME= “Welcome Message”
TYPE= “java.org.lang.String”
DESCRIPTION= “Greeting for the user”>

mapTo(“greeting”)
</PARAMETER>

</OUTPUT>

Corresponding code within the Java™ class file may use the perform( ) method to put a value in the welcomeMsg parameter of the output hashtable. Within the perform( ) method, the put( ) method may be called using the following instruction:

output.put(“welcomeMessage”, msg);

e. The PARAMETER Tag

The <PARAMETER> has attributes that are summarized below in Table 2. When parameters are defined in the DESIGN section of the XML description file, only the NAME and DESCRIPTION attributes apply. With the ENVIRONMENT, INPUT and OUTPUT sections, however, all of the attributes described in Table 2 may apply.

TABLE 2
PARAMETER Attributes

| Attribute Name | Description of Attribute |
|---|---|
| NAME | Name of the parameter |
| DESCRIPTION | The text for a tool tip that appears when a mouse (or other input device) is |
| | placed over an item in process builder. |
| TYPE | A Java ™ object class of the parameter. This attribute is optional and the value |
| | may be given as a complete class name, such as java.lang.String or |
| | com.netscape.pm.ShoppingCart. |
| VALUESET | A comma-defined list of possible values for this parameter. These values may |
| | appear as a pop-up menu in an Inspector Window, and may be optional. |
| EDITOR | The type of editor window to use. For example, this optional attribute may be |
| | used to set a Browse button, text area, drop down list, dialog box. |
| EDITABLE | A Boolean that determines whether the parameter value can be edited in an |
| | Inspector Window. The default may be true and the attribute may be optional. |

f. The DESIGN Section

The DESIGN Section maybe used to define the custom activity's user interface within process builder. The DESIGN section includes <DESIGN> tags that contain embedded <PARAMETER> tags. The <DESIGN> tag has a corresponding closing </DESIGN> tag and each <PARAMETER> tag has a closing </PARAMETER> tag.

As described above, within the DESIGN section, the <PARAMETER> tag accepts only two attributes: NAME and DESCRIPTION. By setting the NAME attribute, a particular aspect of the custom activity may be defined.

g. An Example XML Description File

To facilitate the understanding of the features and principles of the present invention, an example of an XML Description File will be described. The following code defines a file called HelloWorld.xml. The exemplary file specifies userName as a parameter in the input hashtable. The value of this parameter ma be obtained from the customerName data field in the process instance. Furthermore, the exemplary XML file specifies welcomeMsg as a parameter in the output hashtable, and maps its value back into the greeting data field in the process instance.

<?XML version = “1.0 ?>
<WORKPERFORMER

TYPE= “com.netwscape.pm.model . ISimpleWork Performer”
NAME= “HelloWorld”
CLASS_ID= “com.netscape.pm.sample.HelloWorldPerformer”
VERSION= “1.1”>

<ENVIRONMENT>

<PARAMETER

NAME= “Language”
VALUESET= “ ‘English’, ‘French’ ”
TYPE= “java.lang.String”>

‘English’
</PARAMETER>

</ENVIRONMENT>
<INPUT>

<PARAMETER

NAME= “userName”
DISPLAYNAME= “User Name”
TYPE=“java.lang.String”
DESCRIPTION= “Last Name”>

getData( “customerName” )
</PARAMETER>

</INPUT>
<OUTPUT>

<PARAMETER

NAME= “welcomeMsg”
DISPLAYNAME= “Welcome Message”
TYPE= “java.lang.String”
DESCRIPTION= “Greeting for the user”>

mapTo ( “greeting” )
</PARAMETER>

</OUTPUT>
<DESIGN>

<PARAMETER

NAME= “Icon”
DESCRIPTION= “A 32 × 32 icon that is placed on the palette”>
drap_uk2.gif

</PARAMETER>
<PARAMETER

NAME= “Label”
DESCRIPTION= “The DISPLAYNAME for this palette element.”>

HelloWorld
</PARAMETER>
<PARAMETER

Name = “BubbleHelp”
DESCRIPTION= “Bubble help for the palette element”>

HelloWorld - A simple work performer Custom Activity.
</PARAMETER>
<PARAMETER

NAME = “HelpURL”
DESCRIPTION= “URL explaining this palette element”>

http://people.netscape.com/michal/
</PARAMETER>
<PARAMETER

Name = “MapIcon”
DESCRIPTION= “Icon for the process map (48×48)”>

drap_uk2.gif
</PARAMETER>
<PARAMETER

Name = “SelectMapIcon”
DESCRIPTION= “Icon for the process map (48×48)”>

drap_fr2.gif
</PARAMETER>
<PARAMETER

Name = “TreeviewIcon”
DESCRIPTION= “Icon for the tree view (48×48)”>

mailer_tree_view.gif
</PARAMETER>

</DESIGN>
</WORKPERFORMER>

III. Packaging the Custom Activity

After the Java™ class file and XML description files are created, the custom activity may be packaged. A custom activity includes several files that to be archived. The files included in a custom activity are: (1) one or more Java™ classes, with at least one class implementing ISimpleWorkPerformer; (2) an XML description file; and (3) optional image files that may be used as icons in process builder.

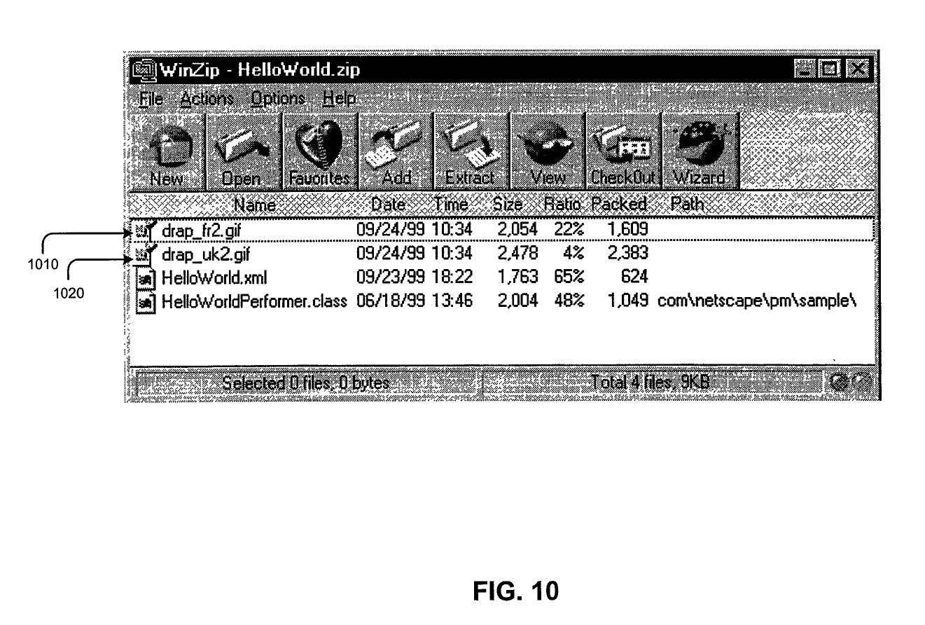

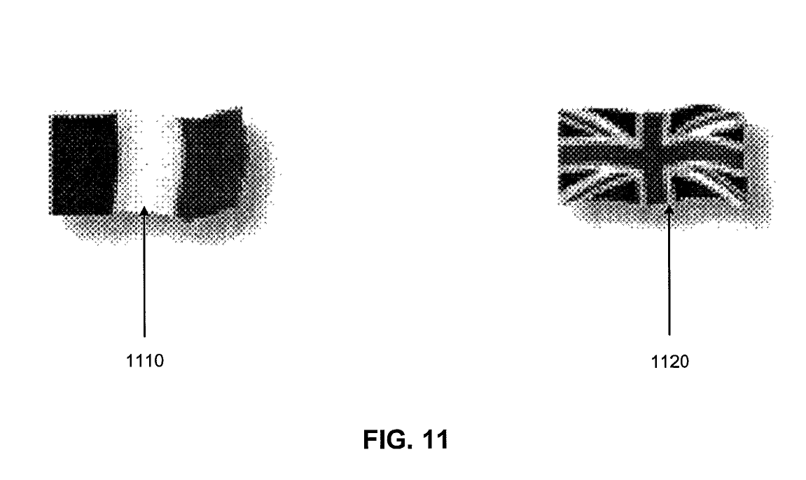

To archive the above noted files, a Java™ ARchive (JAR) or ZIP file is created. A JAR file is an archive of files that an applet may access. The JAR file enables a plurality of files to be included in a request instead of requiring separate HTTP requests for each file stored in the archive file. JAR files are stored in the ZIP file format. The JAR file associated with features of the present invention should have the same root name as the XML file. For example, if the XML file is HelloWorld.xml, then the zip file should be named HelloWorld.zip. As the archive file is created, the directory structure should be checked to ensure that it reflects the package structure of the class. For example, the HelloWorldPerformer class is in the package com.netscape.pm.sample. Therefore, the class file should be placed in the directory com/netscape/pm/sample, as shown in the exemplary archive file window depicted in FIG. 10. As shown in FIG. 10, the HelloWorld.xml file is at the top level. Furthermore, within the window illustrated in FIG. 10, two image files, 1010 and 1020 are shown. These two files may be used by process builder in the process map 720 illustrated in FIG. 7. FIG. 11 shows exemplary images that correlate to the selected state of the Language property. In the examples described above, this includes either French 1110, or English 1120.

IV. Implementing Custom Activities

Once the custom activities are packaged, they are ready for use with a process. The custom activities may be added to the process map 720 in two ways: (1) using a custom palette; or (2) using a standard custom activity icon 735 as shown in FIG. 7.

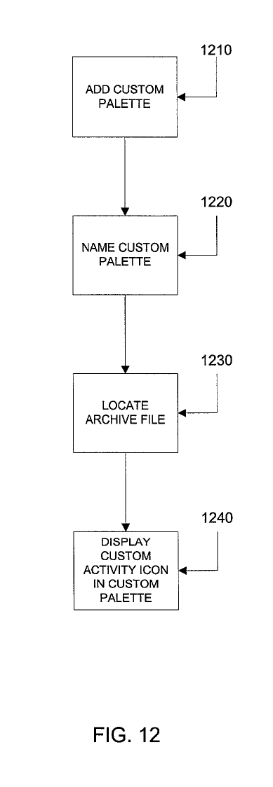

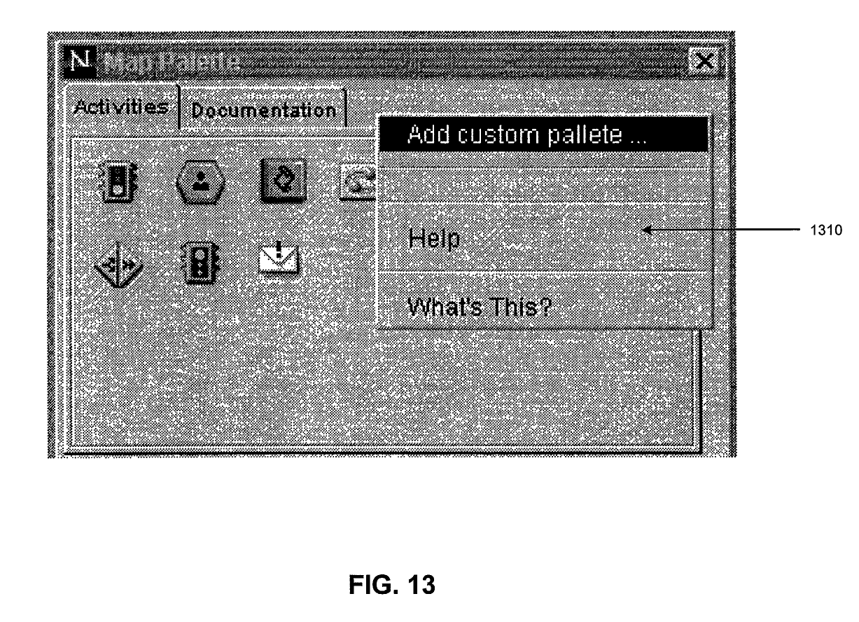

FIG. 12 shows an exemplary process for adding a custom activity to a process map using a custom palette. FIGS. 13-17 illustrates exemplary graphical interfaces that may be implemented when adding a custom activity using a custom palette, consistent with features and principles of the present invention.

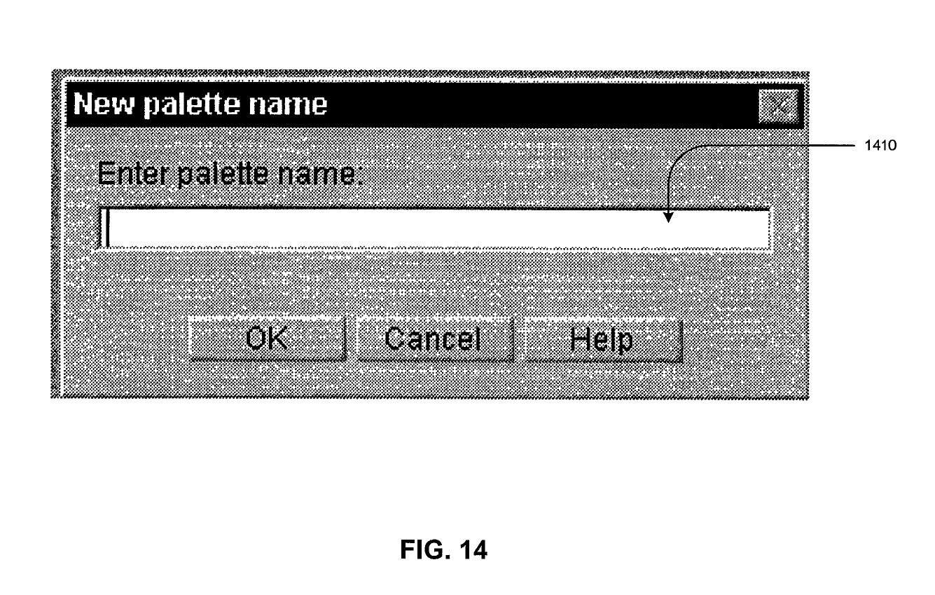

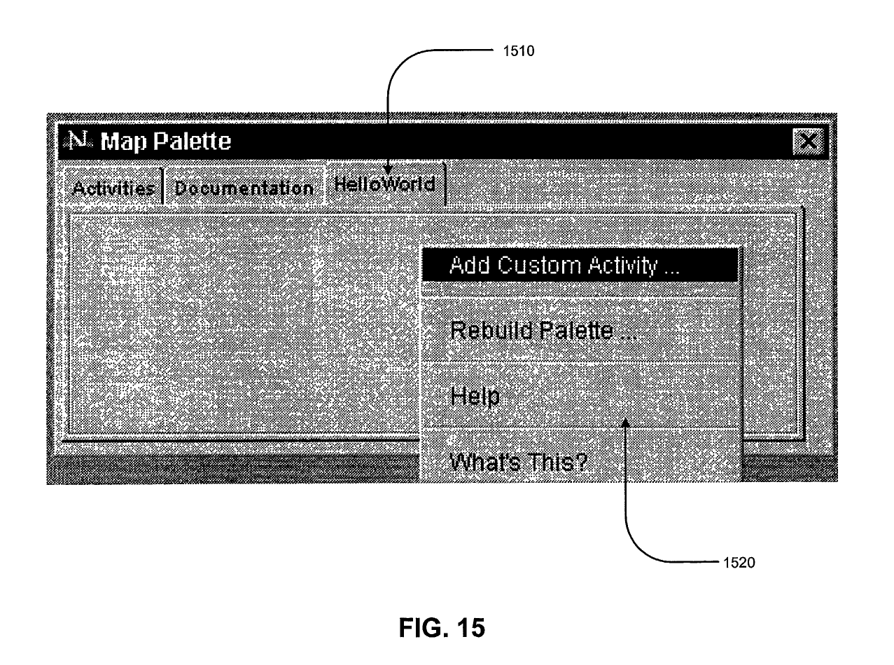

Referring to FIG. 12, to use a custom activity from a custom palette, a user may activate a process dedicated to adding a custom palette (Step 1210). This may be performed by placing a cursor over the map palette window B2 to activate an add custom palette tab 1310 (FIG. 13) to the map palette window. Next, a name is assigned to the custom palette (Step 1220). This may be performed by a user entering the new custom palette's name using a window 1410, as shown in FIG. 14. Once the custom palette's name is provided, a new tab 1510 will appear in the map palette, as shown in FIG. 15. As shown in FIG. 15, the newly named custom palette has the name “HelloWorld,” for exemplary purposes.

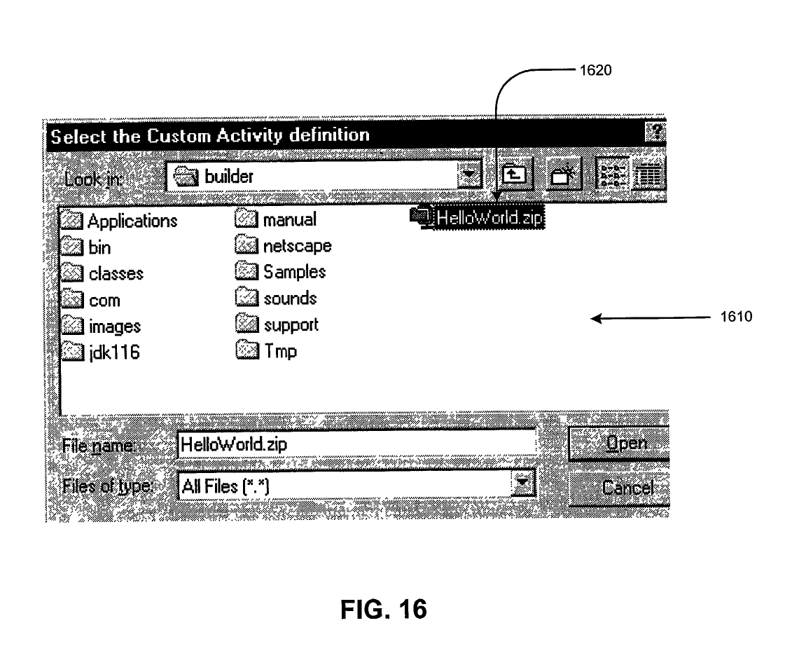

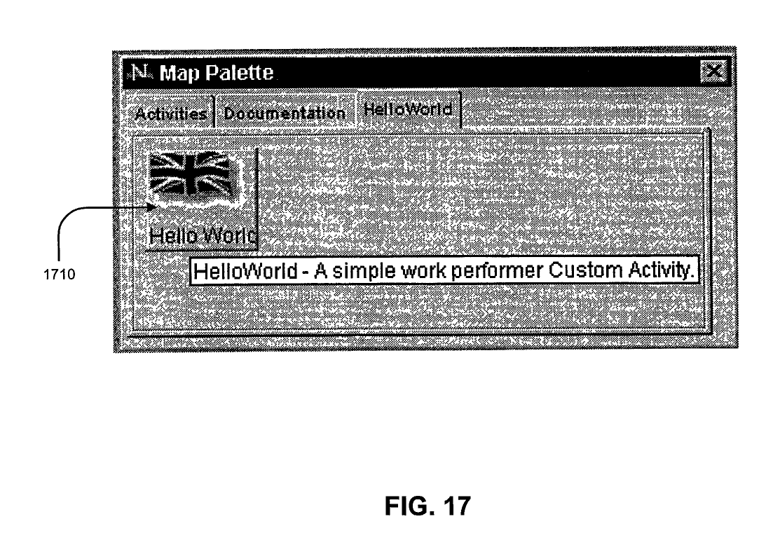

Following the addition of a newly named custom palette, a custom activity is associated with the new custom palette. This may be performed by activating a new tab 1520 in the newly named custom palette tab as shown in FIG. 15. A dedicated process for adding a custom activity may be invoked by selecting it in tab 1520. Once the add custom palette process is initiated, the appropriate archived file that represents the custom activity to be added is found (Step 1230). The archived file may be found by displaying an exemplary file selection window 1610, as shown in FIG. 16. From window 1610, the appropriate archive file that represents the custom activity may be selected. As shown in FIG. 16, the HelloWorld.zip file 1620 is highlighted as it is selected. Once the location of the archive file is found, and selected, the custom activity represented by the archive file is added to the custom palette tab 1610 (Step 1240). FIG. 17 illustrates an exemplary icon 1710 that is generated and added to the HelloWorld custom palette tab. The custom activity's appearance in process builder is controlled by the DESIGN section of the XML file. The exemplary icon 1710 illustrated in FIG. 17 is controlled by the Icon, Label and BubbleHelp parameters in the DESIGN section of the exemplary XML description file discussed above. Once the appropriate archive file is associated with the custom activities custom palette tab, the custom activity may be used in a process by dragging and dropping the icon 1710 onto the process map 720.

In another aspect of the present invention, the custom activity may be added without using a custom palette. In this aspect of the present invention, a custom activity icon 735 such as the one depicted in FIG. 7, may be dragged into the process map 720 by a user. Once dropped into the process map 720, the custom activity 735 is selected the custom activity may be located by finding the archive file that represents the activity. This may be performed by selecting the custom activity in the process map. In response to the selection, an inspector window may be presented from which the archive directory window depicted in FIG. 16 may be presented. As with the custom palette process, the appropriate archive file representing the custom activity is selected, such as HelloWorld.zip 1620. Once an archived file is selected, the process builder associates the custom activity represented by the archive file with the custom activity icon 735 depicted in the map palette 730.

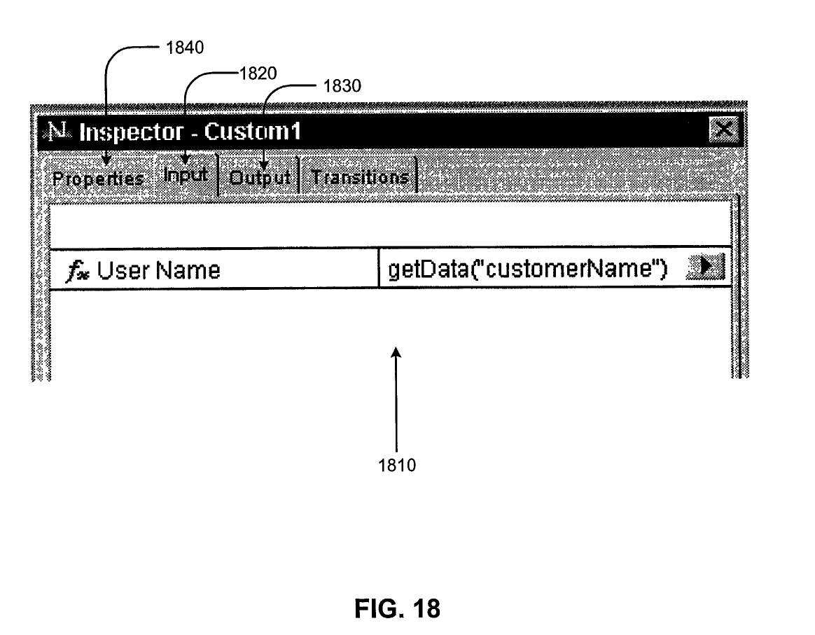

After a custom activity is placed in the process map 720 to be used in a process, the activity's properties may be manipulated. In one aspect of the invention, an inspector window is used to present a custom activity's properties to a user for manipulation. For Example, FIG. 18 shows an exemplary inspector window 1810 that includes an input tab 1820, an output tab 1830, and a properties tab 1840. The input tab 1820 (shown activated in FIG. 18), presents the parameter names in the input hashtable, and shows how each value for each parameter is derived. Following the examples for the HelloWorld custom activity previously described, FIG. 18 shows the value for the input parameter userName is derived by getting the value from the customerName datafield. The INPUT section of the XML description file determines the appearance of the Input tab 1820 in the inspector window 1810. For example, referring back to the exemplary XML description file previously described, and reprinted below, the DISPLAYNAME attribute in the INPUT section of the XML description file specified that the userName parameter would be displayed as “User Name.”

<INPUT>

<PARAMETER

NAME= “userName”
DISPLAYNAME= “User Name”
TYPE= “java.lang.String”
DESCRIPTION= “Last Name”>

getData( “customerName” )
</PARAMETER>

Similar to the Input tab 1820, the Output tab 1820 in FIG. 18 also provides the parameter values in the output hashtable as well as how the value for each parameter is mapped back into the process instance. Referring to the exemplary OUTPUT section of the XML description file described above (and reprinted below), the value for the output parameter welcomeMsg is put in the greeting data field.

<OUTPUT>

<PARAMETER

NAME= “welcomeMsg”
DISPLAYNAME= “Welcome Message”
TYPE= “java.lang.String”
DESCRIPTION= “Greeting for the user”>

mapTo ( “greeting” )
</PARAMETER>

</OUTPUT>

The properties tab 1840 may display selected properties associated with the custom activity. These may include: a name property; a description property; a custom activity property; a version property; an implemented by property; a completion script property; an exception manager property; and a schedule property.

The name property may display the name of the custom activity that appears in the process builder 391 and process express 393. The description property may be an optional description field that provides a more detailed description of the activity that appears in the process express 393. The custom activity property identifies the file that contains the Java™ class and its XML descriptor. This property may be set by a browse window that enables a user to go to an .xml, .zip, or .jar file for use. The version property may reflect the custom activity's version number. The implemented by property may reflect the Java™ class that implements the custom activity. The completion script property may reflect a script that runs when the activity (or step represented by the activity) is completed. The exception manager property reflects an exception manager that may invoke a new work item for correcting an error that was encountered during a process.

The schedule property is used when a deferred activity is defined. As previously described, a deferred activity is an activity that may be invoked automatically at selected times. The schedule property enables users to use the schedule property when a deferred property associated with a custom activity is set. When a process reaches a custom activity that has a deferred property set, the activity will not automatically run, but rather will be deferred. A user may set up a deferred property using the schedule property. The schedule property may enable a user to select times when a deferred activity is to run. A pop-up window may be implemented to facilitate a user friendly process in setting the deferred items for each custom activity.

Once an application is created that employs processes including custom activities, the Java classes the application are deployed to an appropriate folder in a class path on the process manager engine 592. The class path is shared by all applications that are installed in the engines 592. Every application that uses a particular Java class uses the same implementation of that class. For instance, suppose application A and application B both use a Java class SharedClass1. When application A is deployed, its version of SharedClass1 is deployed to the class path. When application B is deployed, its version of SharedClass1 is deployed to the class path, overwriting the implementation deployed previously by application A. Accordingly, in the event multiple applications running on the process manager engines 592 each use the same custom activity, they all should use the same implementation of the custom activity. This procedure is followed because each time the custom activity is deployed to the process manager engines 592, it overwrites the previous implementation of the activity. To facilitate the use of a custom activity that is basically the same but differs lightly from application to application, the name of the activity's Java class should be different in each application.

Custom activities are stateless entities. Therefore, there is only one copy of each occurrence of a custom activity for each application. All process instances within an application effectively share the same custom activity instance for each occurrence of the custom activity class in the application. Accordingly, instance data used in a class that implements a custom activity may be avoided, particularly when the perform( ) method is likely to change this data. However, instance data may be used in classes that implement custom activities by ensuring the data is synchronized.

Additionally, instance variables may be used for data that is constant across all occurrence of a custom activity within an application. For example, consider a vacation request application that uses a custom activity to update a corporate database with a new vacation balance each time the application is executed by an employee. This application may use a global variable that represents a number of company holidays per year. Because this number should not change from employee to employee, using the global variable as a instance variable would not detrimentally affect the custom activity process.

Another example where instance variables would be valid in a custom activity is when the activity needs an application server engine context to call out to a connector such as a Service Advertising Protocol (SAP) connector. SAP is a network protocol used to identify the services and address of servers attached to a network. In this example, the context could be set inside the init( ) method and then re-used inside the perform( ) method. The context object would therefore not be changed in the perform( ) method, but rather would merely be used to perform an activity.

In addition to the above implementation characteristics of custom activities, each application may contain multiple occurrences of a custom activity class. For example, referring to the previous example of a check vacation application, the application may have custom activities called CheckVacationBalance and CheckVacationAccural. These activities may be both instances of a CheckVacationInfo custom activity class. When the application is running, the CheckVacationBalance and checkVacationAccural activities operate independent of each other. Instance data, if used by these custom activities, would not be shared. For instance, if the custom activities use an instance variable called DBTableName, the CheckVacationBalance instance may set the variable to VacBalTable while the CheckVacationAccural instance would set the instance variable to VacAccTable, thus eliminating any confusion between the two.

In order to ensure proper implementation of the custom activities, data types specified within the XML description file should be made consistent with corresponding values passed to the input and output hashtables. Process manager 578 may perform basic data matching to aid in eliminating errors, however using consistent data types in the XML file may eliminate inconsistent data.

As described, systems and methods consistent with features of the present invention enable custom activities to be created and implemented within a workflow process. Such features prevent process designer from being limited to activities that are defined with default functions and enables external data or programming logic to be accessed and used. The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. The invention may be implemented with both object-oriented and non-object-oriented programming systems. Additionally, the configuration of the windows and tabs illustrated in the drawings and described above are not intended to be limiting. That is, and any number of configurations may be utilized to present the information depicted in the windows illustrated in the drawings without departing from the scope of the present invention.

Furthermore, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described embodiments, but instead is defined by the appended claims in light of their full scope of equivalents

What is claimed is:

1. A method for creating an activity within a process management system, comprising:
receiving first data reflecting a class file;
receiving second data reflecting a data representation file;
packaging the first and second data; and
associating the packaged data with an activity that may be used in an automated workflow process to access information external to the process management system.

2. The method of claim 1, wherein the data representation file includes a section that determines the appearance of a representation reflecting the activity.

3. The method of claim 1, wherein the class file includes a method that is configured to obtain a value of a parameter defined in the data representation file.

4. The method of claim 1, wherein receiving first data reflecting a class file includes:
receiving data that defines a package for the class file; and
receiving data that defines methods that retrieve and set values to variables to be used by the activity.

5. The method of claim 4, wherein receiving data that defines methods includes: receiving data that reflects a method that defines variables that are constant across all instances of the activity.

6. The method of claim 5, wherein the method is associated with an input hashtable to define values of a variable used by the activity

7. The method of claim 4, wherein receiving data that defines methods includes:
receiving data reflecting a method that defines values for variables in a first hashtable and retrieves values for variables from a second hashtable.

8. The method of claim 4, wherein receiving data that defines methods includes:
receiving data reflecting a method that releases resources used by an application that implements the activity when the application is unloaded from the process management system.

9. The method of claim 1, wherein receiving second data reflecting a data representation file includes:
receiving data reflecting a first section that defines a type and name of the class file;
receiving data reflecting a second section that defines parameters with values that remain constant within all instances of the activity;
receiving data reflecting a third section that sets values for selected parameters within a first hashtable;
receiving data reflecting a fourth section that defines what to do with parameters included in a second hashtable; and
receiving data reflecting a fifth section associated with a visual representation associated with the activity.

10. The method of claim 1, wherein packaging the first and second data includes:
packaging the first and second data into one of a JAR file or a ZIP file.

11. The method of claim 1, wherein associating the packaged data with an activity includes:
locating the packaged data; and
receiving data reflecting a visual representation that corresponds to the packaged files.

12. A method for implementing a custom activity within a process management environment, comprising:
defining a file associated with a custom activity;
assigning a visual representation associated with the custom activity;
receiving an indication reflecting implementation of the custom activity in a workflow process based on a position of the visual representation in a process map representing the workflow process; and
invoking the file.

13. The method of claim 12, wherein the file is an archive file an includes the visual representation.

14. A method for creating and defining a custom activity within a process management system, comprising:
creating at least one file defining properties associated with the custom activity; and
defining a model associated with the custom activity, wherein the custom activity may be used to access information external to the process manager system.

15. The method of claim 14, wherein the model is an image reflecting the custom activity.

16. The method of claim 14, further comprising:
packaging the file and model into an archive file.

17. The method of claim 14, further comprising:
associating the custom activity with a workflow process managed by the process management system.

18. The method of claim 17, wherein associating the custom activity includes:
determining a position of the model in a visual process map reflecting the workflow process; and
invoking the custom activity in the workflow process based on the determination.

19. The method of claim 14, where in the at least one file includes a Java class file and an XML description file.

20. A method for implementing a custom activity in a process management system, comprising:
creating a process map reflecting an automated workflow process;
creating an image reflecting a custom activity; and
invoking a class defining the custom activity based on a manipulation of the image by a user such that the image is placed in the process map, wherein the custom activity exchanges data with resources external to the process management system.

21. A method for creating a custom activity in a process management system, the custom activity exchanging information with resources external to the process management system, comprising:
receiving a first file and a second file; and
archiving the files in an archive file such that when the custom activity is activated the archived files are accessed and executed.

22. The method of claim 21, wherein receiving the first and second files includes:
receiving package information associated with the first file that implement packages external to the process management system.

23. The method of claim 21, wherein receiving the first and second files includes:
receiving data that interacts with parameters associated with a hashtable defined in the second file.

24. The method of claim 21, wherein receiving the class and XML files includes:
receiving data associated with the second file that defines at least one hashtable used by the first file.

25. The method of claim 21, wherein the first file reflects a class file and the second file reflects an XML file.

26. The method of claim 21, wherein archiving the files includes:
archiving the files in an archive file consisting of one of a JAR file and a ZIP file.

27. A memory for storing data for access by a process being executed by a processor, the memory comprising:
a structure defining a class file and a data representation file, packaging the files, assigning an icon representing the packaged files, and associating the icon with an activity that performs processes defined by the class and data representation files.

28. The memory of claim 27, wherein the data representation file is an XML description file.

29. The memory of claim 28, wherein the XML description file defines the format of the activity.

30. A memory for storing data for access by a process being executed by a processor, the memory comprising:
a structure for maintaining an identity of a custom activity, parameters associated with the custom activity, a first hashtable reflecting data values to be used as input argument in a method, and a second hashtable reflecting output arguments of the method.

31. A memory for storing data for access by a process being executed by a processor, the memory comprising:
a structure for defining a value of a parameter associated with an input hashtable, mapping a value of a parameter associated with an output hashtable, and defining a user interface associated with a custom activity that performs a process based on the values of the parameters in the input and output hashtables.

32. A memory for storing data associated with a custom activity for access by a process being executed by a processor, the memory comprising:
a structure specifying an input tag that obtains a value for an input hashtable to be used as an argument in a method, specifying an output tag that specify parameters that define what to do with parameters in an output hashtable including output arguments associated with the method, and specifying design tags that define a user interface associated with the custom activity.

33. The structure of claim 32, wherein the input, output and design tags each include parameter tags that have attributes defining user interface characteristics associated with the respective tag.

34. A memory for storing data for access by a process being executed by a processor, the memory comprising:
a structure defining a custom activity implemented in a process management system by defining a package for importing packages external to the process management system, defining an init( ) method for defining initialization tasks associated with the custom activity, and defining a perform( ) method for executing tasks associated with the custom activity.

35. The structure of claim 34, wherein the perform( ) method is associated with at least a first hashtable including values corresponding to data fields and a second hashtable including values to be placed in the data fields.

36. The structure of claim 34, wherein the custom activity may have a plurality of instances and wherein the init( ) method defines an association with resources external to the process management system and are shared by all instances of the custom activity.

37. A system for creating and implementing custom activities in a process management environment, comprising:
a processor; and
a memory containing instructions executable by the processor to:
receive a selection to add a custom palette;
receive information reflecting an identifier associated with the custom palette; and
assigning a visual representation to the custom palette reflecting a custom activity that may be used in an automated workflow process to access information external to the process management environment.

38. A system for creating and implementing a custom activity in a process managements environment, comprising:
a processor; and
a memory containing instructions executable by the processor to:
receive a request to generate a palette associated with the custom activity;
assign the custom activity to the palette; and
determine activation of the custom activity based on a manipulation associated with the palette, wherein the custom activity accesses resources external to the process management environment.

39. A system for creating and implementing a custom activity in a process managements environment, comprising:
a processor; and
a memory containing instructions executable by the processor to:
receive a first file defining with an interface with a package external to the process management system;
receive a second file defining parameters that the first file uses;
archive the first and second file in an archive file; and
invoke the first and second file based on a manipulation of an image reflecting the custom activity in a visual process map reflecting an automated workflow process.

40. A computer-readable medium including instructions for performing a method, when executed by a processor, for creating an activity within a process management system, the method comprising:
receiving first data reflecting a class file;
receiving second data reflecting a data representation file;
packaging the first and second data; and
associating the packaged data with an activity that may be used in an automated workflow process to access information external to the process management system.

41. The computer-readable medium of claim 40, wherein the data representation file includes a section that determines the appearance of a representation reflecting the activity.

42. The computer-readable medium of claim 40, wherein the class file includes a method that is configured to obtain a value of a parameter defined in the data representation file.

43. The computer-readable medium of claim 40, wherein receiving first data reflecting a class file includes:
receiving data that defines a package for the class file; and
receiving data that defines methods that retrieve and set values to variables to be used by the activity.

44. The computer-readable medium of claim 43, wherein receiving data that defines methods includes:
receiving data that reflects a method that defines variables that are constant across all instances of the activity.

45. The computer-readable medium of claim 44, wherein the method is associated with an input hashtable to define values of a variable used by the activity

46. The computer-readable medium of claim 43, wherein receiving data that defines methods includes:
receiving data reflecting a method that defines values for variables in a first hashtable and retrieves values for variables from a second hashtable.

47. The computer-readable medium of claim 43, wherein receiving data that defines methods includes:
receiving data reflecting a method that releases resources used by an application that implements the activity when the application is unloaded from the process management system.

48. The computer-readable medium of claim 40, wherein receiving second data reflecting a data representation file includes:
receiving data reflecting a first section that defines a type and name of the class file;
receiving data reflecting a second section that defines parameters with values that remain constant within all instances of the activity;
receiving data reflecting a third section that sets values for selected parameters within a first hashtable;
receiving data reflecting a fourth section that defines what to do with parameters included in a second hashtable; and
receiving data reflecting a fifth section associated with a visual representation associated with the activity.

49. The computer-readable medium of claim 40, wherein packaging the first and second data includes:
packaging the first and second data into one of a JAR file or a ZIP file.

50. The computer-readable medium of claim 40, wherein associating the packaged data with an activity includes:
locating the packaged data; and
receiving data reflecting a visual representation that corresponds to the packaged files.

51. A computer-readable medium including instructions for performing a method, when executed by a processor, for implementing a custom activity within a process management environment, the method comprising:
defining a file associated with a custom activity;
assigning a visual representation associated with the custom activity;
receiving an indication reflecting implementation of the custom activity in a workflow process based on a position of the visual representation in a process map representing the workflow process; and
invoking the file.

52. The computer-readable medium of claim 51, wherein the file is an archive file an includes the visual representation.

53. A computer-readable medium including instructions for performing a method, when executed by a processor, for creating and defining a custom activity within a process management system, the method comprising:
creating at least one file defining properties associated with the custom activity; and
defining a model associated with the custom activity, wherein the custom activity may be used to access information external to the process manager system.

54. The computer-readable medium of claim 53, wherein the model is an image reflecting the custom activity.

55. The computer-readable medium of claim 53, further comprising:
packaging the file and model into an archive file.

56. The computer-readable medium of claim 53, further comprising:
associating the custom activity with a workflow process managed by the process management system.

57. The computer-readable medium of claim 56, wherein associating the custom activity includes:
determining a position of the model in a visual process map reflecting the workflow process; and
invoking the custom activity in the workflow process based on the determination.

58. The computer-readable medium of claim 53, wherein the at least one file includes a Java class file and an XML description file.

59. A computer-readable medium including instructions for performing a method, when executed by a processor, for implementing a custom activity in a process management system, the method comprising:
creating a process map reflecting an automated workflow process;
creating an image reflecting a custom activity; and
invoking a class defining the custom activity based on a manipulation of the image by a user such that the image is placed in the process map, wherein the custom activity exchanges data with resources external to the process management system.

60. A computer-readable medium including instructions for performing a method, when executed by a processor, for creating a custom activity in a process management system, the custom activity exchanging information with resources external to the process management system, the method comprising:
receiving a first file and a second file; and
archiving the files in an archive file such that when the custom activity is activated the archived files are accessed and executed.

61. The computer-readable medium of claim 60, wherein receiving the first and second files includes:
receiving package information associated with the first file that implement packages external to the process management system.

62. The computer-readable medium of claim 60, wherein receiving the first and second files includes:
receiving data that interacts with parameters associated with a hashtable defined in the second file.

63. The computer-readable medium of claim 60, wherein receiving the class and XML files includes:
receiving data associated with the second file that defines at least one hashtable used by the first file.

64. The computer-readable medium of claim 60, wherein the first file reflects a class file and the second file reflects an XML file.

65. The computer-readable medium of claim 60, wherein archiving the files includes:
archiving the files in an archive file consisting of one of a JAR file and a ZIP file.

66. A system for creating an activity within a process management system, comprising:
means for receiving first data reflecting a class file;
means for receiving second data reflecting a data representation file;
means for packaging the first and second data; and
means for associating the packaged data with an activity that may be used in an automated workflow process to access information external to the process management system.

67. The system of claim 66, wherein the data representation file includes a section that determines the appearance of a representation reflecting the activity.

68. The system of claim 66, wherein the class file includes a method that is configured to obtain a value of a parameter defined in the data representation file.

69. The system of claim 66, wherein the means for receiving first data reflecting a class file includes:
means for receiving data that defines a package for the class file; and
means for receiving data that defines methods that retrieve and set values to variables to be used by the activity.

70. The system of claim 69, wherein the means for receiving data that defines methods includes:
means for receiving data that reflects a method that defines variables that are constant across all instances of the activity.

71. The system of claim 70, wherein the method is associated with an input hashtable to define values of a variable used by the activity

72. The system of claim 69, wherein the means for receiving data that defines methods includes:
means for receiving data reflecting a method that defines values for variables in a first hashtable and retrieves values for variables from a second hashtable.

73. The system of claim 69, wherein the means for receiving data that defines methods includes:
means for receiving data reflecting a method that releases resources used by an application that implements the activity when the application is unloaded from the process management system.

74. The system of claim 66, wherein the means for receiving second data reflecting a data representation file includes:
means for receiving data reflecting a first section that defines a type and name of the class file;
means for receiving data reflecting a second section that defines parameters with values that remain constant within all instances of the activity;
means for receiving data reflecting a third section that sets values for selected parameters within a first hashtable;
means for receiving data reflecting a fourth section that defines what to do with parameters included in a second hashtable; and
means for receiving data reflecting a fifth section associated with a visual representation associated with the activity.

75. The system of claim 66, wherein the means for packaging the first and second data includes:
packaging the first and second data into one of a JAR file or a ZIP file.

76. The system of claim 66, wherein the means for associating the packaged data with an activity includes:
means for locating the packaged data; and
means for receiving data reflecting a visual representation that corresponds to the packaged files.

77. A system for implementing a custom activity within a process management environment, comprising:
means for defining a file associated with a custom activity;
means for assigning a visual representation associated with the custom activity;
means for receiving an indication reflecting implementation of the custom activity in a workflow process based on a position of the visual representation in a process map representing the workflow process; and
means for invoking the file.

78. The system of claim 77, wherein the file is an archive file an includes the visual representation.

79. A system for creating and defining a custom activity within a process management system, comprising:
means for creating at least one file defining properties associated with the custom activity; and
means for defining a model associated with the custom activity, wherein the custom activity may be used to access information external to the process manager system.

80. The system of claim 79, wherein the model is an image reflecting the custom activity.

81. The system of claim 79, further comprising:
means for packaging the file and model into an archive file.

82. The system of claim 79, further comprising:
means for associating the custom activity with a workflow process managed by the process management system.

83. The system of claim 82, wherein the means for associating the custom activity includes:
means for determining a position of the model in a visual process map reflecting the workflow process; and
means for invoking the custom activity in the workflow process based on the determination.

84. The system of claim 79, wherein the at least one file includes a Java class file and an XML description file.

85. A system for implementing a custom activity in a process management system, comprising:
means for creating a process map reflecting an automated workflow process;
means for creating an image reflecting a custom activity; and
means for invoking a class defining the custom activity based on a manipulation of the image by a user such that the image is placed in the process map, wherein the custom activity exchanges data with resources external to the process management system.

86. A system for creating a custom activity in a process management system, the custom activity exchanging information with resources external to the process management system, comprising:
means for receiving a first file and a second file; and
means for archiving the files in an archive file such that when the custom activity is activated the archived files are accessed and executed.

87. The system of claim 86, wherein the means for receiving the first and second files includes:
means for receiving package information associated with the first file that implement packages external to the process management system.

88. The system of claim 86, wherein the means for receiving the first and second files includes:
means for receiving data that interacts with parameters associated with a hashtable defined in the second file.

89. The system of claim 86, wherein the means for receiving the class and XML files includes:
means for receiving data associated with the second file that defines at least one hashtable used by the first file.

90. The system of claim 86, wherein the first file reflects a class file and the second file reflects an XML file.

91. The system of claim 86, wherein the means for archiving the files includes:
means for archiving the files in an archive file consisting of one of a JAR file and a ZIP file.
